(19) United States
(12) Patent Application Publication
(10) Pub. No.: US 2014/0137542 A1
(43) Pub. Date: May 22, 2014

(54) CONTROLLED PYROTECHNIC TRAIN

(71) Applicant: RAFAEL ADVANCED DEFENSE SYSTEMS LTD., Haifa (IL)

(72) Inventors: Shai Rahimi, Kyriat Motzkin (IL); Roei Naveh, Shimshit (IL)

(21) Appl. No.: 14/129,979

(22) PCT Filed: Jun. 28, 2012
(86) PCT No.: PCT/IB12/53276

§ 371 Date: Dec. 29, 2013

(30) Foreign Application Priority Data
Jun. 29, 2011 (IL) 213830

(51) Int. Cl. F02K 9/95

(52) U.S. Cl. CPC F02K 9/95
USPC 60/256

(57) ABSTRACT

A controlled pyrotechnic train implementing a MEMS chip portion for use as an igniter of a charge. The pyrotechnic train includes an initiator; a blocker configured to block the train; a deflector of the blocker; and an output charge. The blocker is displaceable by the action of the deflector.

### CROSS REFERENCE TO RELATED APPLICATIONS

This application is a national stage entry of International Application PCT/IB2012/053276, entitled “Controlled Pyrotechnic Train”, filed Jun. 28, 2011; and claims priority from Israel patent application 61/447,054, “Controlled Pyrotechnic Train”, filed Jun. 29, 2011, the entire contents of which are incorporated herein by reference.

### FIELD OF THE INVENTION

The present invention relates to igniters and detonation in the context of a pyrotechnic train, in particular the invention relates to igniters in which a controllable interrupter is embedded.

### BACKGROUND OF THE INVENTION

Igniting an energetic device such as a warhead or a rocket motor requires that the device is assembled and delivers its energy according to a schedule. Such a schedule ensures that the device does not undergo unintentional activation. A “detonation train” also known as “explosive train” is the reference given to the chain of activation elements, starting with the initiating element and ending with the explosive device itself. Generally, each link in the chain is separated from the preceding one by a barrier such as an activation energy barrier or a mechanical barrier that has to be surpassed in order to facilitate activation of the next link. The pyrotechnic train is a term relating to a succession of initiator and charges that eventually respond to the initiator. In various applications, the prevention of unintentional detonation of the explosive device is of special significance. The “safe and arm” approach is one such method, in which an electrical powering first stage is required to initiate the train, and a mechanically manipulated interrupting mechanism is responsible for the controlled prevention of the train conveying the activation energy to the explosive device.

MEMS (micro electromechanical systems) devices were disclosed that perform as safe and arm devices, for example U.S. Pat. No. 7,069,861 and U.S. Pat. No. 7,052,562. Such micro-devices function in micro scale as to mechanically manipulate the explosive train to prevent unintentional activation of the explosive device.

### SUMMARY OF THE INVENTION

The present invention provides a controlled pyrotechnic train implementing a MEMS chip portion for use as an igniter of a charge. The pyrotechnic train includes an initiator; a blocker configured to block the train; a deflector of the blocker; and an output charge. The blocker is displaceable by the action of the deflector.

### BRIEF DESCRIPTION OF THE DRAWINGS

FIG. 1 is a schematic sequence diagram showing the detonation train in which the present invention is implemented;

FIG. 2 is a schematic isometric view showing the external structural aspects of an igniter of the present invention;

FIGS. 3A-3C are a series of schematic isometric views showing the assembly of the MEMS chip on the header of the igniter;

FIGS. 4A-4C are a series of schematic isometric views showing the functional aspects of a blocker, and its displacement mechanism;

FIGS. 5A-5B are a series of schematic isometric views showing the functional aspects of the blocker blocking the entrance to an output charge capsule; and

FIGS. 6A-6D are a series of schematic isometric views showing some structural aspects of the blocker blocking the optical path in the case of the initiator being a laser beam.

### DETAILED DESCRIPTION OF EMBODIMENTS OF THE INVENTION

Definition and clarification: throughout the present description, the term “charge” relates to a pyrotechnic device, also known as an “explosive device” and not to an electric charge.

In accordance with an embodiment of the present invention, an igniter features a detonation train interruptible by a barrier implemented using MEMS technology. As the initiator in this embodiment, a semiconductor bridge (SCB) is employed. Such SCB igniter was demonstrated in several prior art publications. U.S. Pat. No. 5,861,570 describes the SCB structural aspects whose juxtaposition with respect to the primary charge is essential to the transfer of energy of the igniter in the form of plasma.

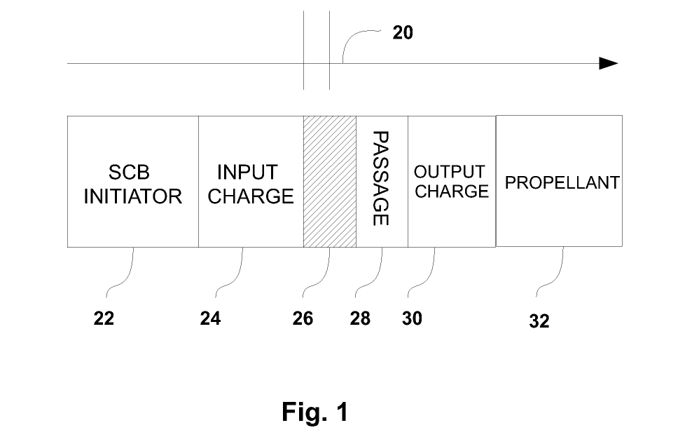

Referring first to FIG. 1, there is shown in general, the detonation train in accordance with an embodiment of the invention. Typically, the detonation train of the invention is implemented in association with a rocket to provide safe ignition. The detonation train, constituting a sequence of events, is initiated by SCB initiator 22 which is fed by a predetermined current, causing it to heat, producing a reactive environment that is able to set input charge 24, which is disposed contacting initiator 22, into an activation, such that it detonates and produces heat and energetic products. At this point along the detonation train, block 26 may be deployed or shifted away, according to which state the detonation train may stop or progress, respectively. Passageway 28 disposed after block 26 is able to channel hot plasma and gasses, if the block is shifted away, delivering some of it to output charge 30. The output charge, when and if detonated activates propellant 32 that drives the rocket.

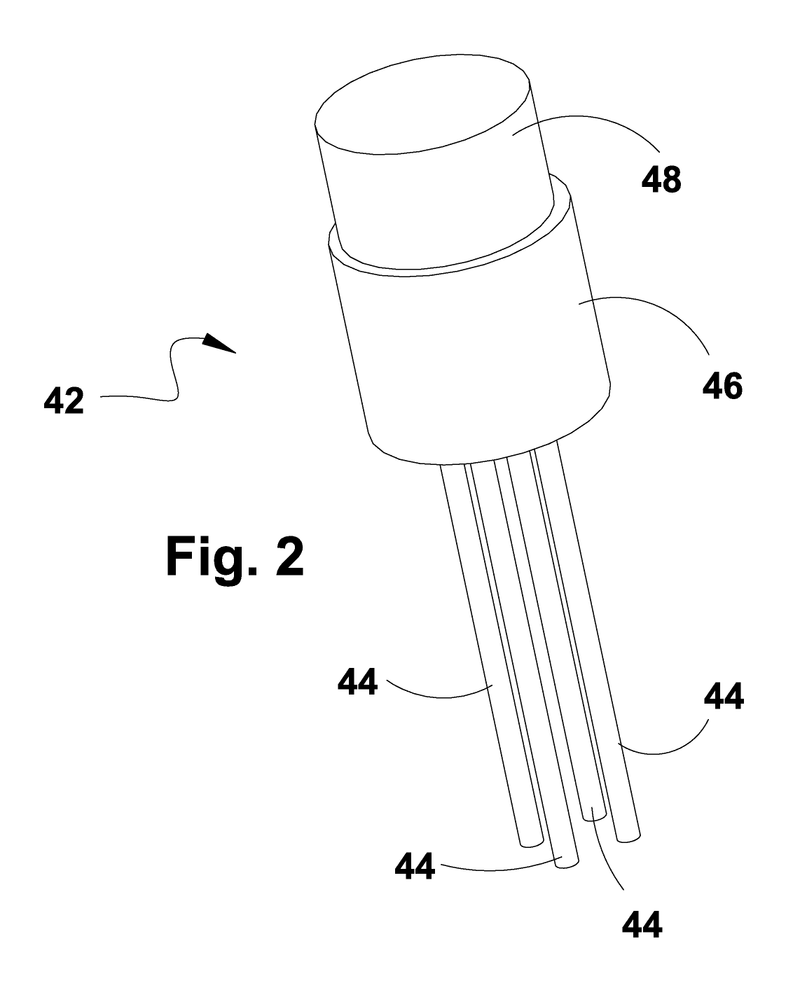

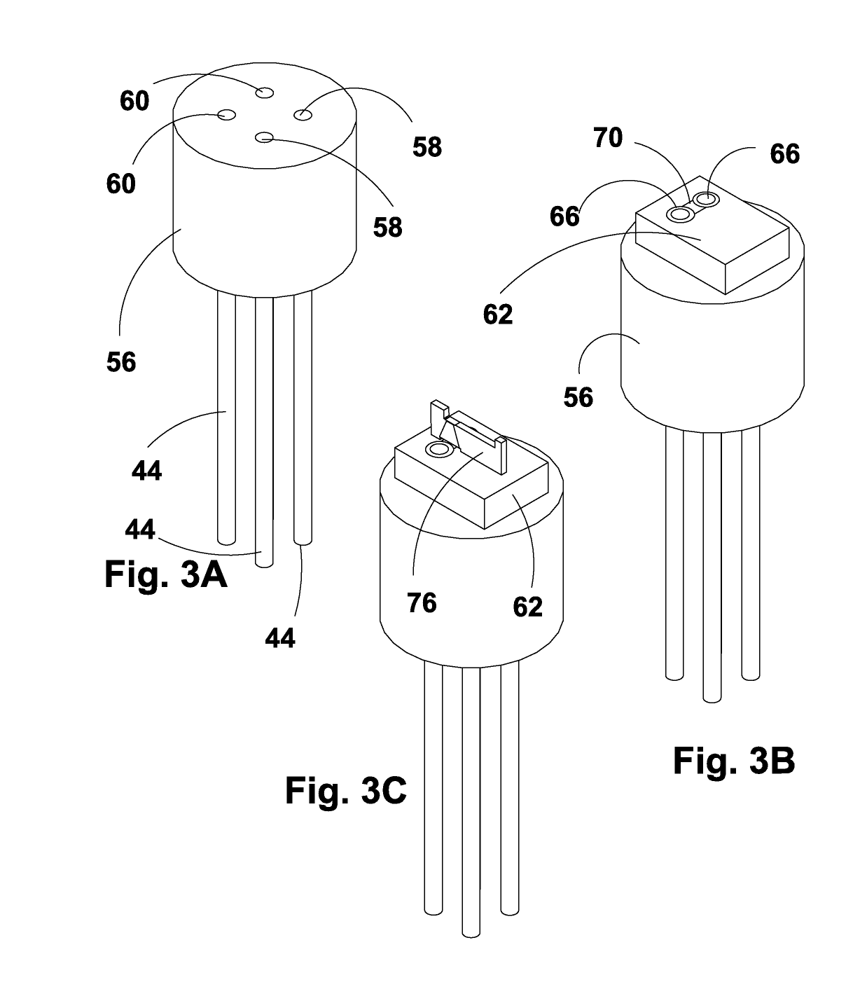

To describe structural aspects of the igniter of the invention, reference is first made to FIG. 2. Igniter 42 has four galvanic contacts 44, the role of which will be explained below. Contacts 44 connect to detonation train housing 46 and residing on top is output charge capsule 48. The charge in this capsule is either a primary or a secondary charge. More details are described in FIGS. 3A-C.

In FIG. 3A, galvanic contacts 44 of which only three are shown, end each in the header 56, their exposed ends 58 (two) and 60 (two) are shown on the topside of header 56. In FIG. 3B, contact layer 62 is shown laid over the topside of header 56, covering the exposed ends of galvanic contacts 44. However, contact layer 62, includes two galvanic contact pads 66, which correspond each to one respective contact end 60. In between contact pads 66, initiator 70 connects at its two ends to a respective contact pad 66. As to the nature of the initiator, this can be inferred from U.S. Pat. No. 7,430,963 the contents of which, relating to the initiator, are incorporated herein by reference.

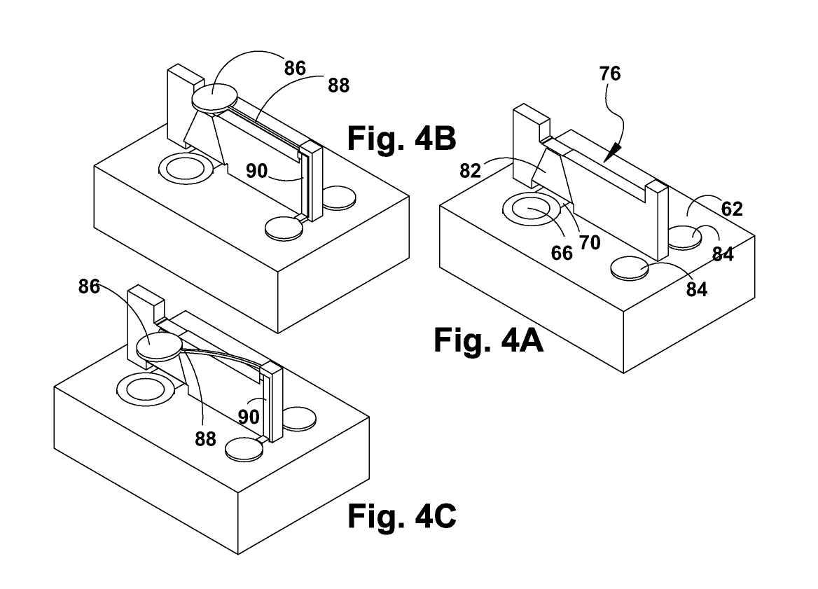

In FIG. 3B, another link in the pyrotechnic train of the invention is shown. Perpendicular assembly (PA) 76 made of inert substrate resides with its narrow flank on contact layer 62. Further details of the PA and its relations with other parts of the system in which the present invention is implemented are explained with reference to FIGS. 4A-4C. In FIG. 4A, contact layer 62 resides on top of the header, not shown, and contact pad 66 connects to initiator 70, while PA 76 is attached to contact layer 62, covering some or almost all of initiator 70. Input charge 82 is inserted inside a compatible niche inside PA 76, in this example in the shape of a trapezoid with the narrow base pointing upwards. Two contact pads 84 are visible on top of contact layer 62, and their role is to provide current to an actuation mechanism on PA 76, as will be elaborated below.

In FIG. 4B, another feature of the system is shown. Blocker 86 is attached to a deflector, which in this case is angular deflector 88, capable of displacing the blocker sideways as can be seen in FIG. 4C, typically on a plane perpendicular to PA 76. When blocker 86 is displaced sideways, input charge 82, wedged inside PA 76, has its upper side exposed except for a thin layer of the silicon of the PA, which in most cases covers input charge 82.

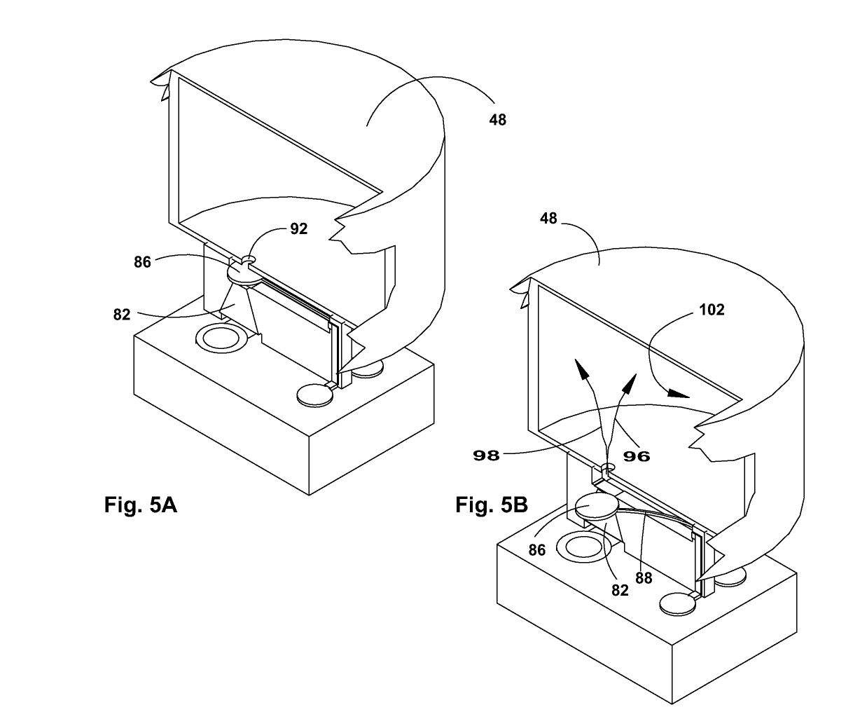

In the detonation train, embodying the present invention, an output charge capsule 48, typically containing a secondary charge, is described externally in FIG. 2, and further dealt with in more details hereinafter, with reference to FIGS. 5A-5B.

In FIG. 5A, blocker 86 is shown located right above input charge 82, while a through bore 92 connecting the outside atmosphere with the inside of output charge capsule 48 is located right above blocker 86. When blocker 86 is deflected sideways as shown in FIG. 5B, the passage of energetic material from the detonation of input charge 82 through bore 92 is unhindered and flow of such material as shown by arrows 96 and 98 into inner space 102 of capsule 48 is made possible. The displacement of blocker 86 is caused by the curving of angular deflector 88.

### Actuation Mechanisms

A deflector as described above as angular deflector 88 may be embodied by employing one of several technical approaches. A piezoelectric element is one viable option. In such a case the piezoelectric element, typically a thin layer of specially fabricated piezoelectric material is fed by electric leads such that when an electric field is applied to it, the piezoelectric element curves, thus deflecting the attached blocker. Piezoelectric devices of the type applicable in this case, are such devices containing more than one type of ceramic element or a ceramic element and a metal component. When voltage is applied across the junction between the two elements a considerable curvature occurs.

In case an SMA (shape memory alloy) metal alloy is used, the bending of the angular deflector such as described in FIG. 4C above may be brought about by a change in temperature. The change in temperature in turn may be brought about by a Peltier cooler or heater. Another option is that instead of angular deflector 88, a linear deflector shortens upon heating/cooling exposing the input charge without bending.

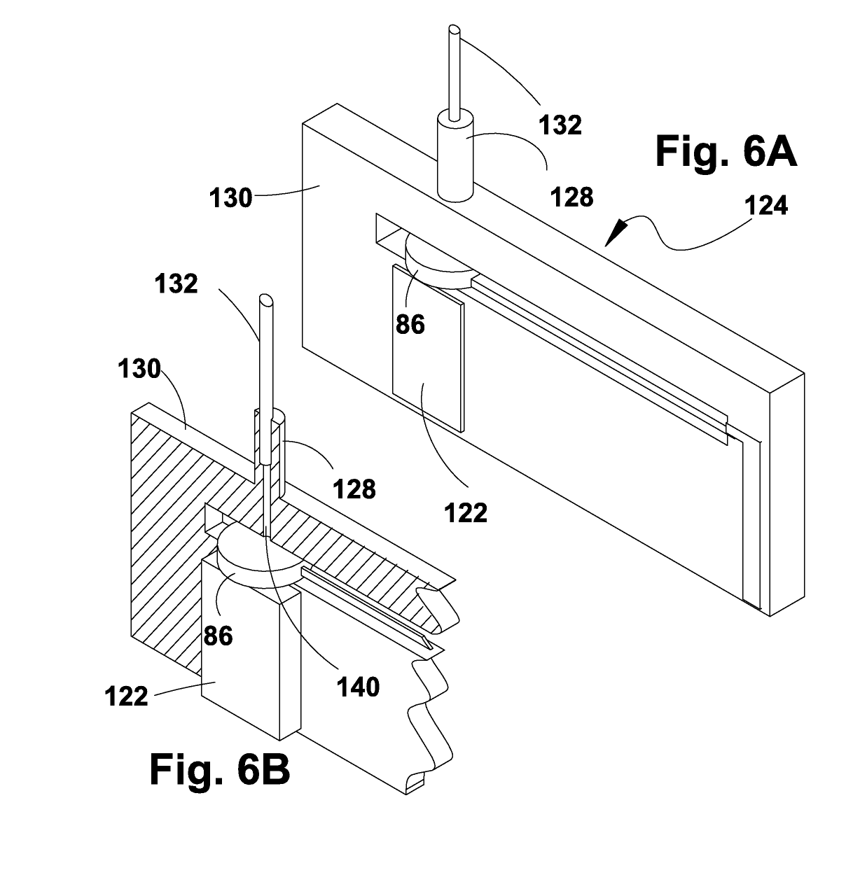

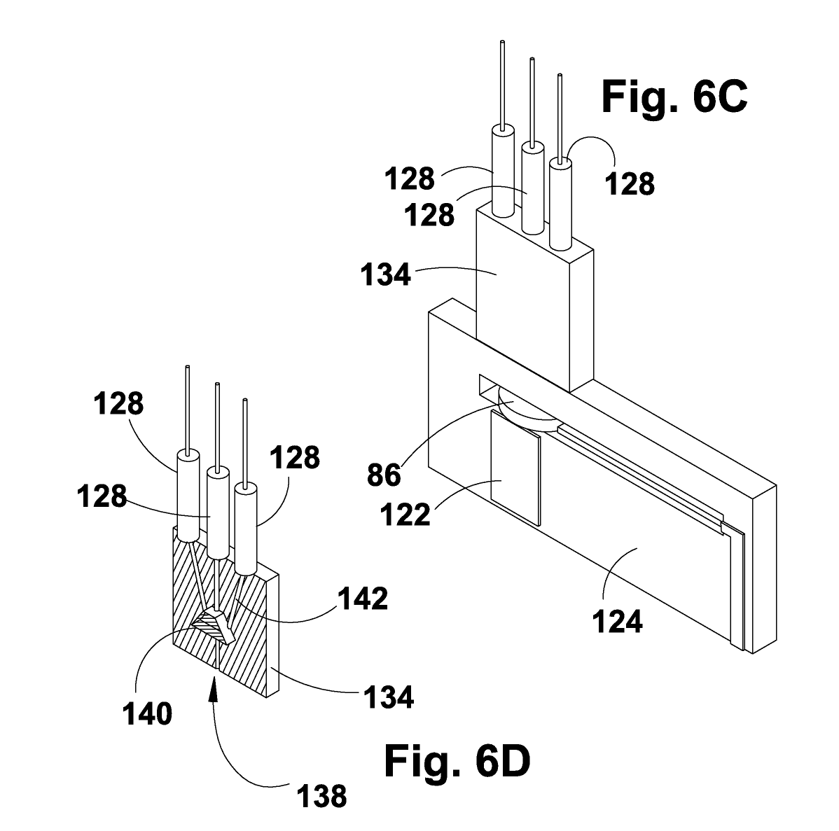

In another embodiment of the invention, the initiator is a laser beam, typically issuing power in the form of light rays of more than one watt, which is utilized to detonate a secondary charge. An exemplary embodiment is described schematically in FIGS. 6A-6B.

In FIG. 6A, laser diode 122 or LED, is incorporated in a MEMS based assembly 124 in which blocker 86 is capable of blocking the optical path between diode 122 and fiber adaptor 128 attached to block 130, and subsequently preventing the optical signal from travelling along fiber 132.

In FIG. 6B, a cross sectional view in MEMS assembly 124 of FIG. 6A is described, showing bore 140 in sectioned block 130. This bore allows light coming from laser diode 122 to reach fiber 132 when blocker 86 is displaced sideways.

In FIG. 6C, selector switch 134 is capable of selecting a specific fiber adaptor out of a plurality of adaptors 128 connected. Such a selection is brought about by electric interaction with control module (not shown) connected to the MEMS chip. Selector switch 134 facilitates passage of light energy from laser diode 122 to a specific fiber connected by the respective adaptor and eventually to respective charge, provided two conditions are met: (a) blocker 86 is set out of the way; and (b) selector switch 134 is set to select a the specific route associated with the selected adaptor.

In FIG. 6D a cross sectional view in selector switch 134 is shown which demonstrates light input canal 138 in which light from laser diode 122 (not shown) is sent into diverter 141, which directs the beam to any channel such as channel 142. Diverter 140 is actuated by power arriving from a source on MEMS based assembly 124. The shifting of light rays from input canal 138 into any of adaptors 128 may be achieved by a rotating mirror or a rotating prism having a rotation axis normal to the large face of switch 134. Accurate rotation of such optical ray diverter may be actuated by a piezoelectric actuator.

In the light actuation embodiments of the invention, the blocker is not necessarily a mechanical appliance, it may be embodied as a device used in optics such as a shutter, a mirror, a polarizer etc. If a mirror is used as a blocker, a beam dump may be required to absorb/dissipate the reflected beam.

What is claimed is:

1. A controlled pyrotechnic train implementing a MEMS chip portion for use as an igniter of a charge, comprising:
an initiator;
a blocker configured to block said train;
a deflector of said blocker; and
an output charge,
wherein said blocker is displaceable by the action of said deflector.

2. The train according to claim 1, wherein said deflector is a piezoelectric device.

3. The train according to claim 1, wherein said blocker is capable of blocking a detonation train.

4. The train according to claim 1, wherein said deflector is a mechanical angular deflector.

5. The train according to claim 1, wherein said deflector is a mechanical linear deflector.

6. The train according to claim 1, wherein said initiator is a laser beam.

7. The train according to claim 6, wherein said blocker is a device used in optics.

8. The train according to claim 6, wherein a selector switch is interposed between a source of said laser beam and at least two charges, wherein said selector switch is capable of selecting one fiber adaptor of at least two fibers, said one fiber is associated with a respective charge.
